(19) United States
(12) Patent Application Publication
(10) Pub. No.: US 2010/0169639 A1
(43) Pub. Date: Jul. 1, 2010

(54) METHOD FOR MANAGING A GLOBALLY ACCESSIBLE OPERATIONAL DATA WAREHOUSE SYSTEM WITH IMPROVED SECURITY AND CONSUMER RESPONSE

(76) Inventors: William Jeffries, Centerville, VA (US); Kamal Mustafa, North Caldwell, NJ (US)

Correspondence Address: LACKENBACH SIEGEL, LLP, LACKENBACH SIEGEL BUILDING, 1 CHASE ROAD, SCARSDALE, NY, 10583, US

(21) Appl. No.: 12/531,172

(22) PCT Filed: Mar. 17, 2008
(86) PCT No.: PCT/US08/57294

§ 371 Date: Jan. 19, 2010

Related U.S. Application Data
(60) Provisional application No. 60/895,140, filed on Mar. 15, 2007.
(60) Provisional application No. 60/895,100, filed on Mar. 15, 2007.
(60) Provisional application No. 60/947,567, filed on Jul. 2, 2007.
(60) Provisional application No. 60/986,817, filed on Nov. 9, 2007.
(60) Provisional application No. 60/913,536, filed on Apr. 23, 2007.

(51) Int. Cl. G06F 21/24; H04L 29/06; H04L 9/32; H04L 9/08; G06F 17/00; G06Q 10/00; G06Q 50/00; G06Q 30/00

(52) U.S. Cl. 713/153; 713/170; 380/279; 707/736; 705/50; 707/E17.005

(57) ABSTRACT

A secure data exchange and access system, method, and architecture for allow web-based data transfer with improved security and scalability. The system incorporates and enables serialized pedigree systems while allowing security for storing, authenticating, and tracking a change of custody of a serialized item along a transfer chain. A plurality of independent databases, respectively blind to each other but for a global construct, retains pieces of information along a product supply chain. Specific encryption/decryption protocols enable secure information transfer in a number of modes including a post point of sale anti-counterfeiting system that includes a process for consumer involvement as a triggering mechanism.

### CROSS REFERENCE TO APPLICATIONS

This Application references and claims priority from in U.S. Ser. No. 60/895,100 filed Mar. 15, 2007 (Ref. No. SECUR.P026), U.S. Ser. No. 60/895,140 filed Mar. 15, 2007 (Ref. No. SECUR.P027), U.S. Ser. No. 60/913,535 filed Apr. 23, 2007 (Ref. No. SECUR.P028) and U.S. Ser. No. 60/947,567 filed Jul. 2, 2007 (Ref. No. SECUR.P029), and U.S. Ser. No. 60/986,817 filed Nov. 9, 2007 (Ref No. SECUR.P033); the entire contents of each of which are herein incorporated fully by reference.

### FIGURE SELECTED FOR PUBLICATION

FIG. 1

### BACKGROUND OF THE INVENTION

1. Field of the Invention

The present invention relates to a system, apparatus, and method for enabling an operational data warehouse with improved security features and flexibility. More specifically, the present invention relates to a secure architecture and system for data storage enabling specified access and reporting structures allowing reporting and authentication throughout a product supply chain, including at a post-point of sale.

2. Description of the Related Art

The related art involves conventional enterprise data warehouse architectures involving ERP or enterprise resource planning constructions. These conventional systems are an adaptation of a design rather than a design built specifically for the task and are therefore limited. These limitations reduce usability and are constantly contributing to the so-called “conflicts” in the conventional data-warehousing world between custom design and task design.

These limitations particularly include how to deal with time-sharing demands, primary key issues causing parent-child complexities, cascading change impacts, difficulties in near real-time loading during operation, troublesome query access, problematic drill-down analysis, top down architecture and unavoidable top-down implementation, and perhaps most troubling limitations security and scalability/flexibility.

The particularly thorny problem of data security is evident in conventional systems when multiple access points are provided for particularized data fields or tables within a schema that are cross-linked to other tables or fields within the overall schema. Where certain aspects of data should be divulged to only particular users but not others, the open access typical of such systems is readily broached (intentionally or accidentally).

The additional thorny problems of scalability and flexibility involve how to manage rapid increases in access and input points (for example a rapid increase of external users who both input and extract data), while ensure security between parties and also how to ensure flexibility for differing types of external users and differing types of data flows.

Ultimately, the cascading problems of security, scalability, and flexibility have a cascading effect on conventional processes and detrimentally impacts particularly larger conventional data models. The associated conventional system architecture and design suffer as a result.

In a conventional database management system (DBMS), data is stored in one or more data containers, each container contains records, and the data within each record is organized into one or more fields. In relational database systems, the data containers are referred to as tables, the records are referred to as rows, and the fields are referred to as columns. In object oriented databases, the data containers are referred to as object classes, the records are referred to as objects, and the fields are referred to as attributes. Other database architectures may use other terminology.

Systems that implement the present invention are not limited to any particular type of data container or database architecture. While the particular descriptions do not delve into the inter structures of a database schema other than as noted, for the purpose of explanation, the examples and the terminology used herein shall be that typically associated with relational databases. Thus, the terms “table”, “row” and “column” shall be used herein to refer respectively to the data container, record, and field.

Conventionally, for various reasons, it may not be desirable for all users to have access to all of the rows of a particular table for security reasons. For example, certain rows of a table may contain top secret information, other rows may contain secret information, while other rows contain unclassified information. Under these conditions, the rows made available to any given user should be dictated by the security clearance of that user, after the use has gained access to the actual database itself. This situation conventionally requires row-level filtering of data to enforce an access-control policy. To enforce row-level access-control policies, a conventional database server must have a mechanism for restricting users to particular subsets of the rows within tables, conventionally this employs secure passwords which may be lost, forgotten, sold, transferred, or simply copied by others—all to the detriment of ultimate security and secure access to the data in a database. One technique for implementing row-level access-control policies involves causing all access to a table to be performed indirectly through “views”.

A view is a logical table. As logical tables, views may be queried by users as if they were a table. However, views actually present data that is extracted or derived from existing tables. A view is defined by metadata referred to as a view definition. The view definition contains mappings to one or more columns in the one or more tables containing the data. Typically, the view definition is in the form of a database query. Columns and tables that are mapped to a view are referred to herein as base columns and base tables of the view, respectively. To restrict a user to a particular subset of rows within a table, the user may be granted rights to access a view that extracts from the table only those rows that belong to that particular subset.

Various related solutions have been proposed, and are discussed briefly below, but not are responsive to the particular requirements. A first example involves U.S. Pat. No. 5,893,118 (Sonderegger), the entire contents of which are incorporated herein by reference. In U.S. Pat. No. 5,893,118 a method and a system are proposed that make securing, licensing, and growing capability of various directory services available for use within an environment of Java script/language to provide an alternative security restriction via Java applets. This solution fails to address the compatibility needs between differently related customer/manager databases, and the need to achieve an enhanced encryption required for governmental regulation.

Also recognized is U.S. Pat. No. 5,481,700 (Thuraisingham), the entire contents of which are incorporated herein by reference. In U.S. Pat. No. 5,481,700, an apparatus is provided for designing a multilevel secure database management system based on a multilevel logic programming system. The apparatus includes a multilevel knowledge base which has a multilevel database in which data are classified at different security levels. The multilevel knowledge base also includes schema, which describe the data in the database, and rules, which are used to deduce new data. Also included are integrity constraints, which are constraints enforced on the data, and security constraints, which are rules that assign security levels to the data. The system further includes users cleared to the different security levels. The multilevel database management system makes deductions and gives complete answers to queries and prevents certain unauthorized inferences. Since it is based upon and requires direct user access, this system is unable to achieve the required level of security.

Finally, U.S. Pat. No. 6,578,037 (Wong et al.) the entire contents of which are incorporated herein by reference. In U.S. Pat. No. 6,578,037 a technique is provided for controlling access to data in a database system. Here, groups of security policies are established for a database schema object, such as a table or a view. A security policy reflects access rules for accessing the database schema object. Access to the database schema object is restricted based on security policy groups selected for the user. The security policy groups are selected based on information associated with a user that is maintained or accessed by the database system. A default security policy is established and used to restrict access of users accessing the database schema object. The information associated with the user contains an attribute that identifies a policy group. This security technique is narrowly focused on group policies and actually requires detrimental database management details, including user access into the secure database itself.

Data Vault constructions are also appreciated in the related art for specific applications, often with in single “stove-pipe” type uses in a monolithic company, see for example “Data Vault Overview: The Next Evolution In Data Modeling” by D. Linsted (www.tdan.com/i021hy01.htm). These types of data vaults have benefits useful to a monolithic company, but the structures proposed fail to function in the dynamic commercial and regulatory environment where cross-data development, reporting, and transfers must be carefully managed.

To date, what is not appreciated by the prior art is the need for a unique data vault system with supporting architecture and operational modes that overcome the detriments noted above while also ensuring fail-safe data access by diverse users (manufactures, re-packagers, retailers, and others throughout an integrated system and along a supply chain). Accordingly, applicants propose an improved operational system, apparatus, and method for enabling an operational data warehouse with improved security, flexibility and scalability.

Through development of the present system, applicants have additionally determined that consumers were not easily aware of counterfeit products in the pharmaceutical field, for example those purchased via the internet, mail order supply houses or from conventional retailers. Often counterfeit pharmaceutical products are visually indistinguishable from valid product. Consequently, consumers are at a loss to authenticate their product even if the product itself or its packaging possessed an identifying code.

Similarly, conventional systems operate on a consumer first seeking confirmation on authenticity from point of sale retailers via personal-human approach, mail or telephone. Conventional retail systems are often unable to readily verify authenticity even to the particular store of purchase. Consequently, manufacturers were often late in receiving notice of counterfeit products bearing their brand names or other markings.

Ultimately, this late delivery of counterfeit information combined with the difficulty consumer's face in authenticating a product of concern raise substantial legal liability concerns for product manufacturers, even those with precision serialized product identification systems such as promoted by Applicant's earlier efforts.

To date, what is not appreciated by the related art, apart from Applicant, is the need for a secure manufacturer focused post-point of sale counterfeiting system that brings information relating to counterfeits immediately to the attention of the manufacturer. Accordingly, there is a need for a post point of sale anti-counterfeiting system to serve the needs of both consumers and manufactures with enhanced delivery times and other benefits as shall be noted herein.

### PROPOSED SUMMARY OF THE INVENTION

A proposed benefit of the present invention is to provide aspects of a system, apparatus, and method for enabling an operational data warehouse with improved security features and flexibility allowing security involving a plurality of independent database servers both within and external to one more firewalls.

More specifically, a proposed benefit of the present invention relates to a secure architecture and system for data storage enabling specified access and reporting structures that access a plurality of individualized databases unique to respective customers.

One particular problem appreciated by the applicants is the need to maintain secure and provable communication integrity when receiving information from, and supplying information to, diverse manufacturers, diverse retailers, diverse supply and distribution stream participants; where each participant requires independent security measures that are not intermingled with other system participants. Additionally the problem further requires a method, system, or arrangement that prevents obsolescence and provides an adaptable yet sterile data environment.

A possible benefit of the proposed present invention is to provide a unique data solution allowing ready deployment across a range of industries that is highly secure from the perspectives of system managers, customers/users, and from governmental or state agencies. These perspectives for governmental and state agencies include adherence to standards now existing (for example the standards within the Proscription Drug Marketing Act (PDMA) (21 C.F.R. 202 et ct.), standards within the Homeland Security Authorization Acts, and others)

The present invention relates to a secure data exchange and access system, method, and architecture for enabling web-based data transfer with improved security, flexibility and scalability. The proposed system incorporates and enables a variety of serialized pedigree systems while allowing true security for storing, authenticating, and tracking or tracing a change of custody of a serialized item such as a pharmaceutical product. A plurality of independent databases, respectively blind to each other but for a global construct or global data management and warehouse schema, retain pieces of information along a product supply chain and purchase chain. Software and customer specific encryption/decryption protocols enable data reconstruction and secure information transfer in a number of modes.

According to an embodiment of the present invention there is provided a database system for storing, authenticating, and tracking or tracing the chain of custody of serialized items such as pharmaceutical products. The system includes independent database servers housing data which, by itself, has no value in authenticating or tracing serialized items (each separate machine, blind to the others, only holds pieces of an entire pedigree/authenticating path). Software and decryption/encryption keys, owned by particular third parties are the only way to reconstruct a complete data set for a serialized item and only a master software construction allows separate pieces to be assembled in a secure manner. Additionally, individualized serial numbers for respective tracking items are hashed (one-way encrypted), making the original serial number completely unrecoverable, even to the hashing-agent. Only the serialized item carries the serial number itself, yet the master software enables authentication by hashing a submitted serial number and comparing the same to the database-stored hashed serial number. In this way, the proposed system allows serialized codes to be authenticated without storing the actual value in the database.

The present invention also relates to a post point of sale anti-counterfeiting system and method, based upon the construction disclosed for enabling a turn-key post point of sale anti-counterfeit system. A point of sale consumer purchases an identified product and at a post point of sale interval seeks to confirm authenticity. The consumer accesses a consumer interface such as a web site, telephone link or other secure interface commonly contracting to a management party to provide both point of sale purchase information and the identified product information. The consumer receives a record regarding product authentication and a product manufacturer receives direct information regarding the authenticity of a product, location, and much more. The manufacturer or central database proposed, or both may support the consumer interface or via a variety of contracting service providing parties given secure access. External contacts such as law enforcement and supply chain members may also interact with the system to enhance security and anti-counterfeiting measures.

Applicant's proposed system empowers the manufacturer with an effective tool for identifying, tracking, and eliminating drug counterfeiters while at the same time offering an exceptional public relations opportunity by providing an important step toward protecting the consumer. The system meets the manufacturer's requirements under existing and future federal and state regulations, including the PDMA and the 2009 California pedigree law.

In one aspect of the present invention, at a pharmaceutical manufacturer's packaging line, the proposed system module (as noted in the descriptions incorporated by reference) prints a unique, encrypted, serialized alphanumeric code together (“UESAC”) with a composite barcode (See FIG. 16). The UESAC contains the encrypted information of standard linear barcode, including the lot, expiration date, and NDC numbers.

The composite barcode contains substantially more information, but for the present system it allows expansion of the system to a complete e-pedigree (electronic pedigree). Via advertising channels, a pharmaceutical company will make the consumer aware of the simple steps necessary to verify the authenticity of the drug they have purchased regardless of the source.

Accessing a consumer authentication interface commonly hosted by a contracting party such as a phone-in service provider or call center, the consumer will be asked to enter at the minimum the encrypted UESAC, a method of identifying himself, and purchase location information onto the special, private labeled website or through a touch tone phone. At that point the product will be authenticated and at the discretion of the pharmaceutical company, the consumer will be able to print out a record of authenticity or similarly, if done through a phone link, that record of authenticity can be mailed to the consumer.

Simultaneously, the drug company is receiving specific information on lot numbers correlated with geographic location of individual packages being sold, making the database of tracking down counterfeits and illegally diverted drugs more robust. Once the specific serial number is checked off in the secure database any subsequent input of the same number (such as from a counterfeit carton), would immediately be identified as being fake. Irrespective of where the individual drug package travels, the customer can verify its authenticity at or beyond the point of purchase.

The above and other objects, features and advantages of the present invention will become apparent from the following description read in conduction with the accompanying drawings, in which like reference numerals designate the same elements.

### BRIEF DESCRIPTION OF THE DRAWINGS

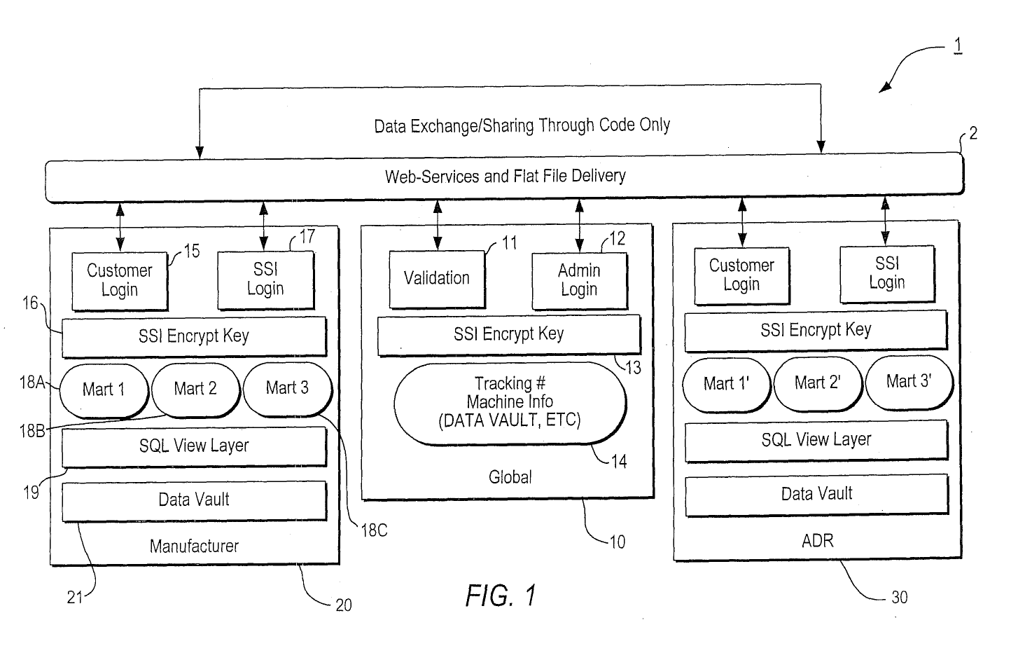

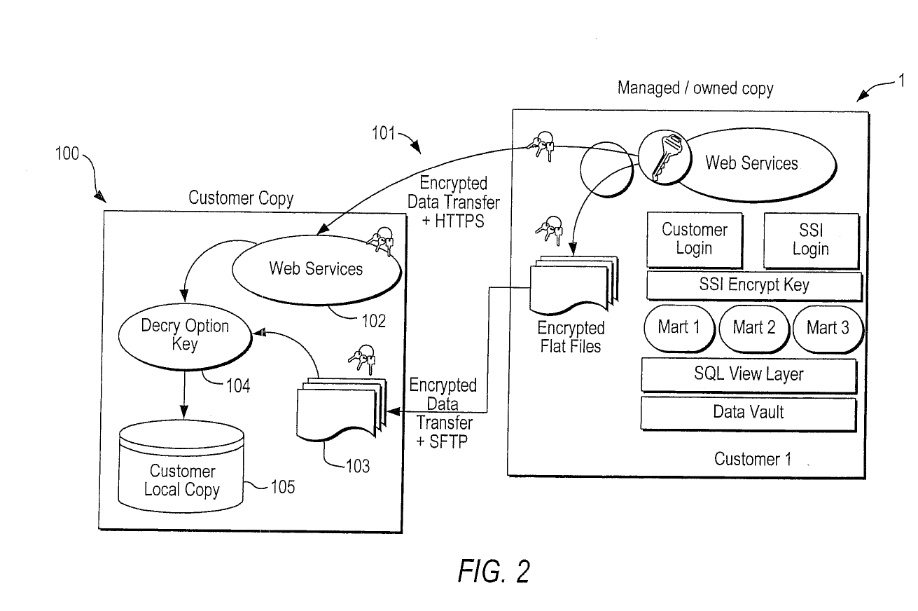

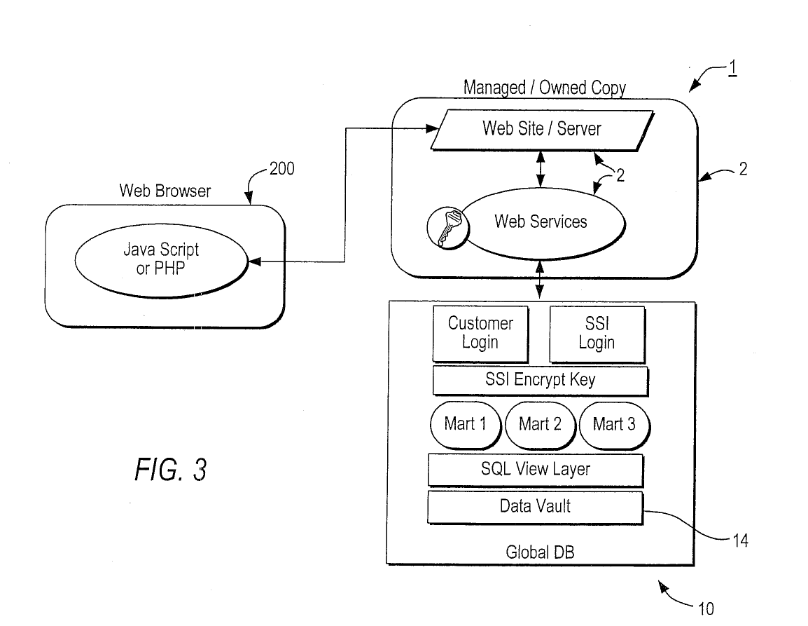

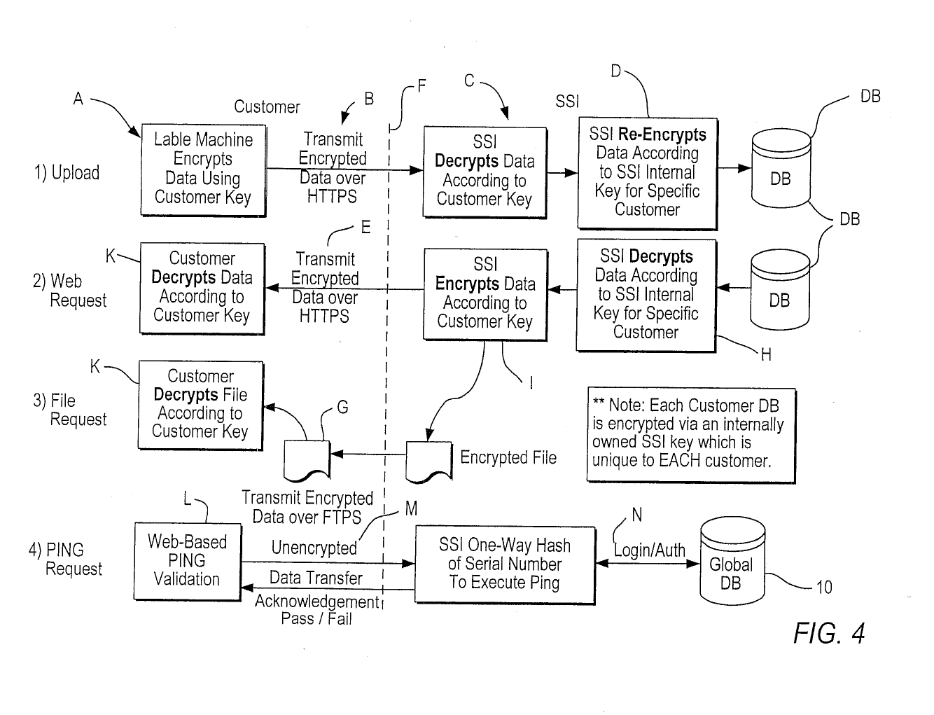

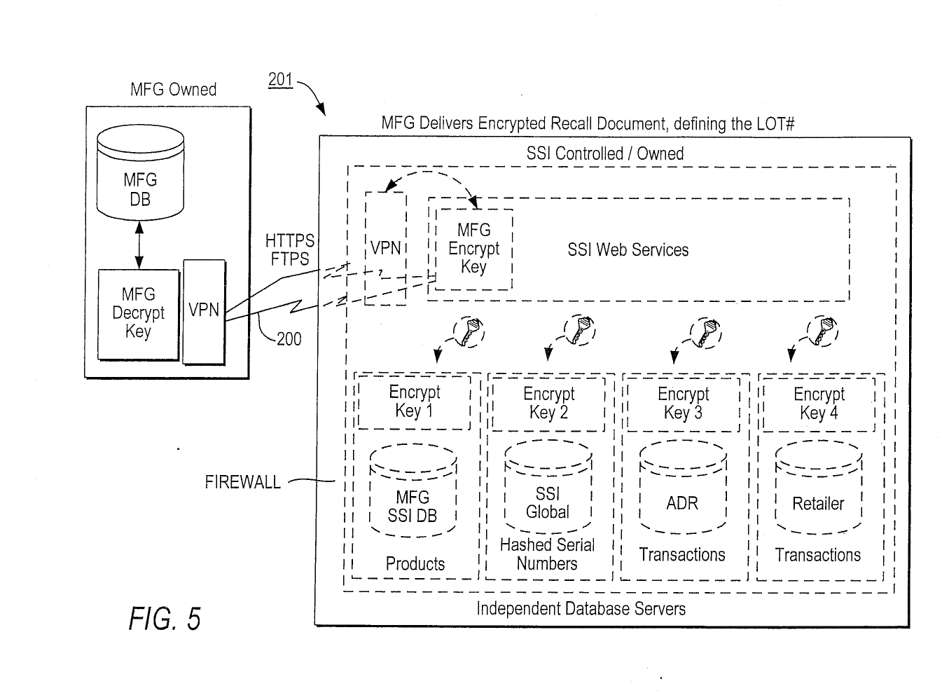

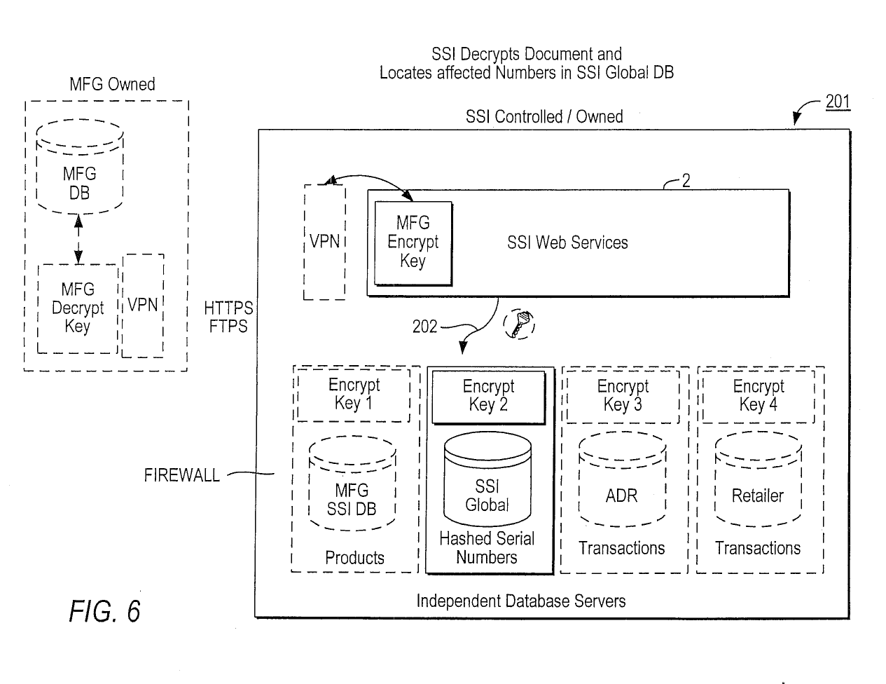

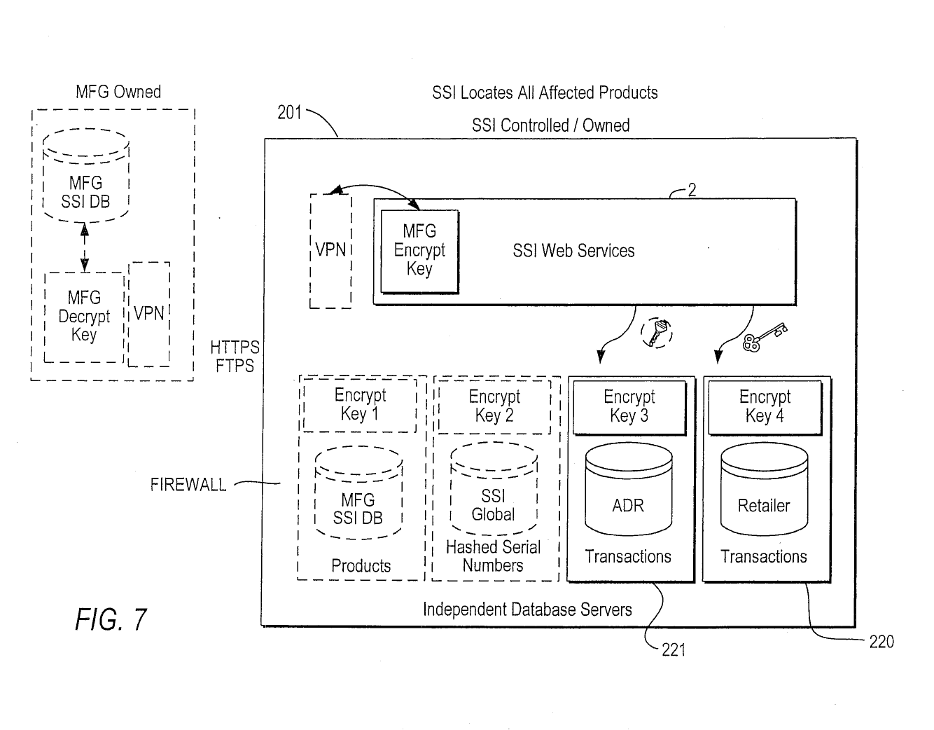

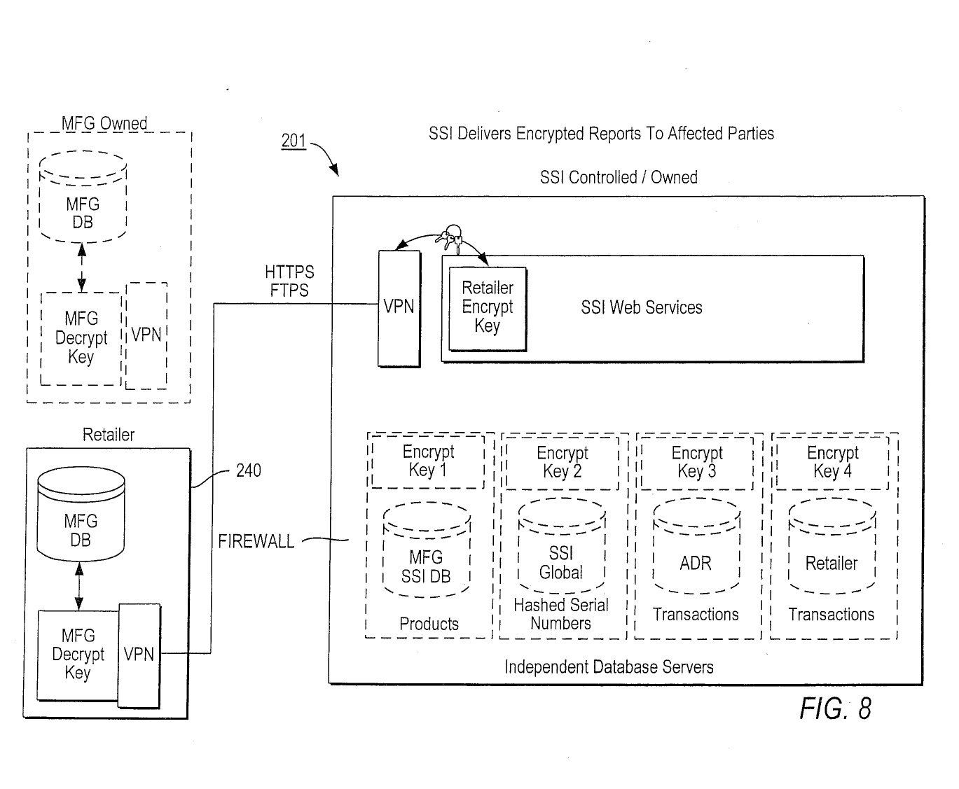

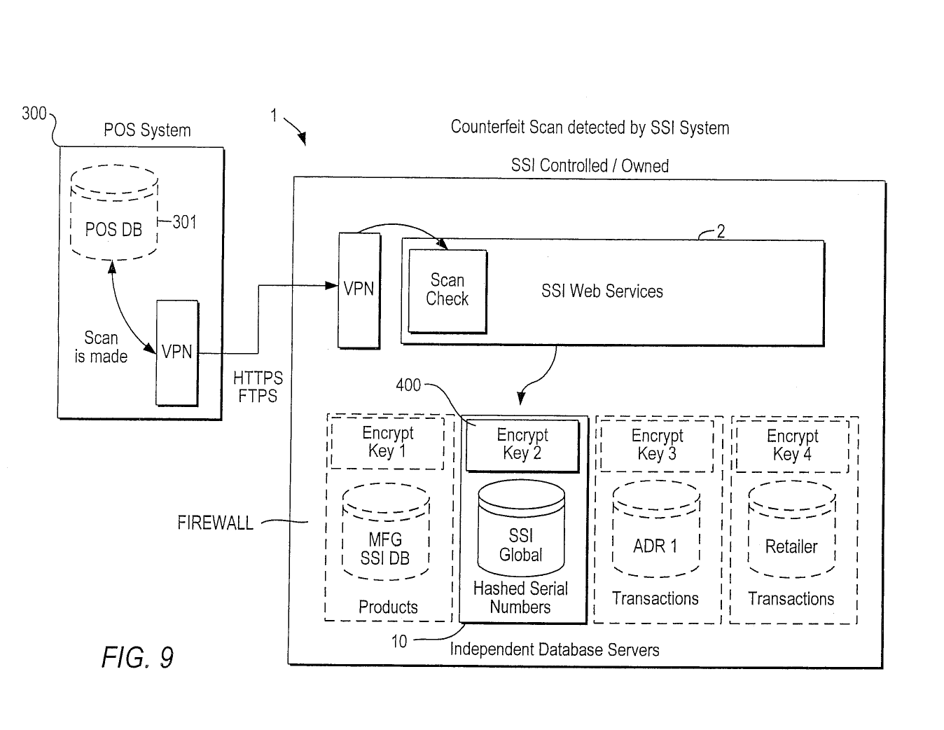

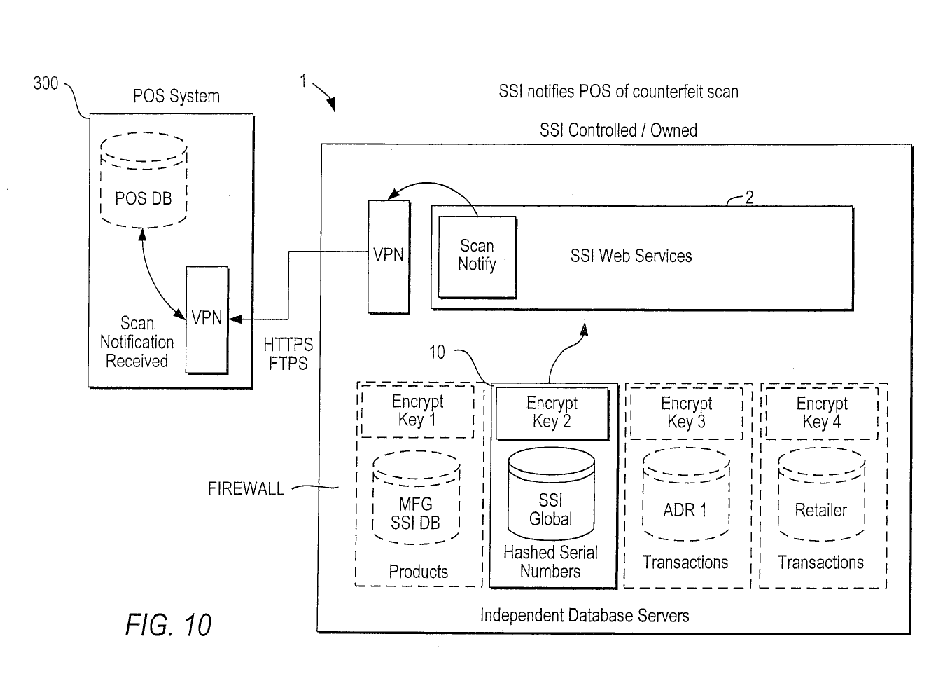

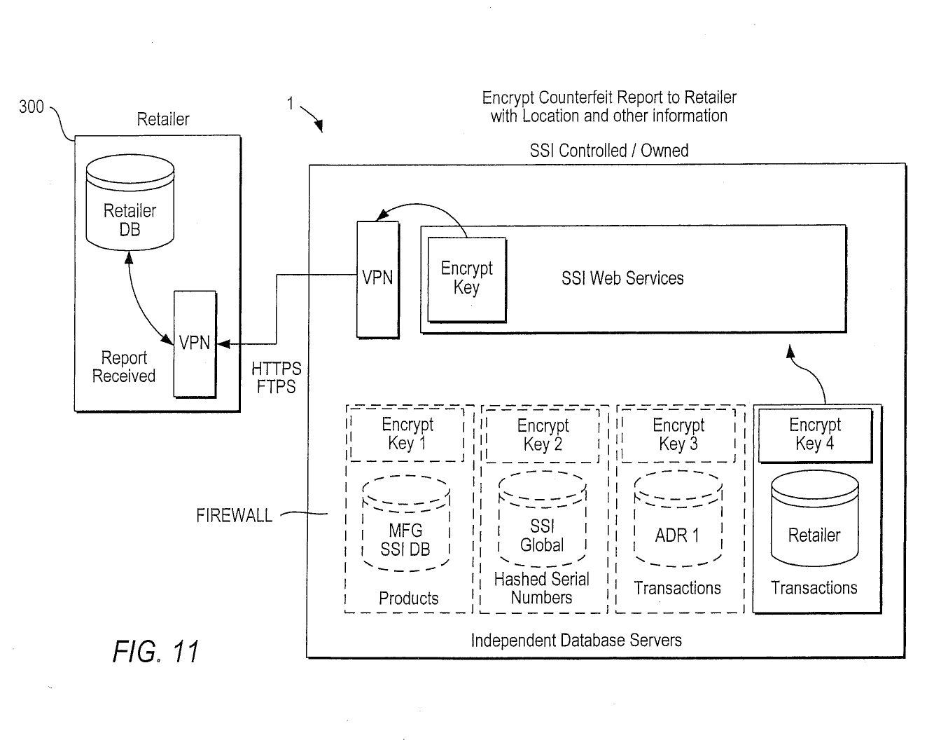

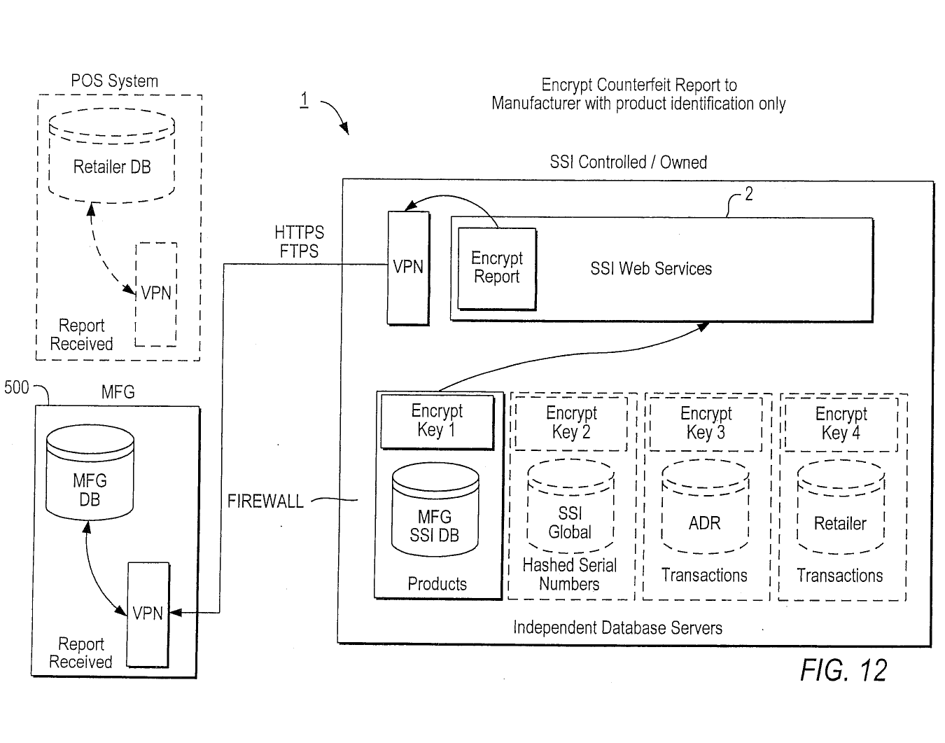

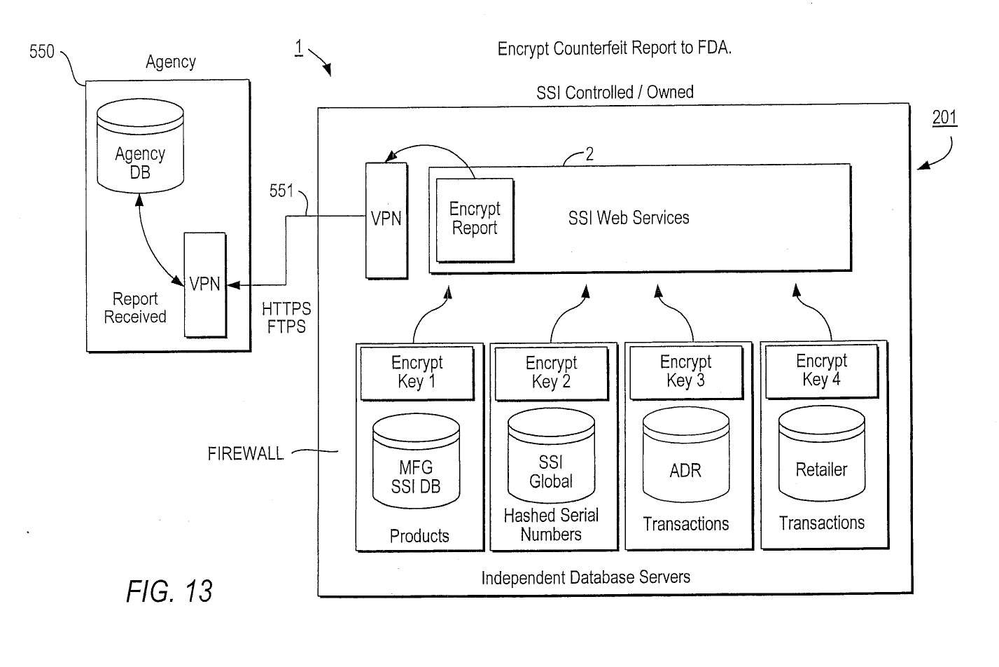

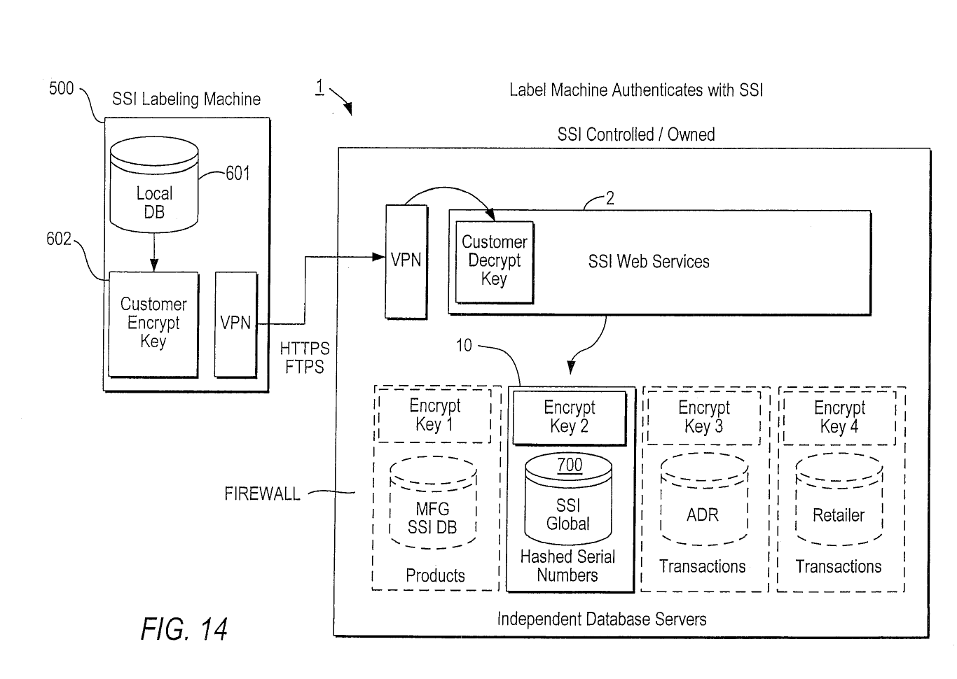

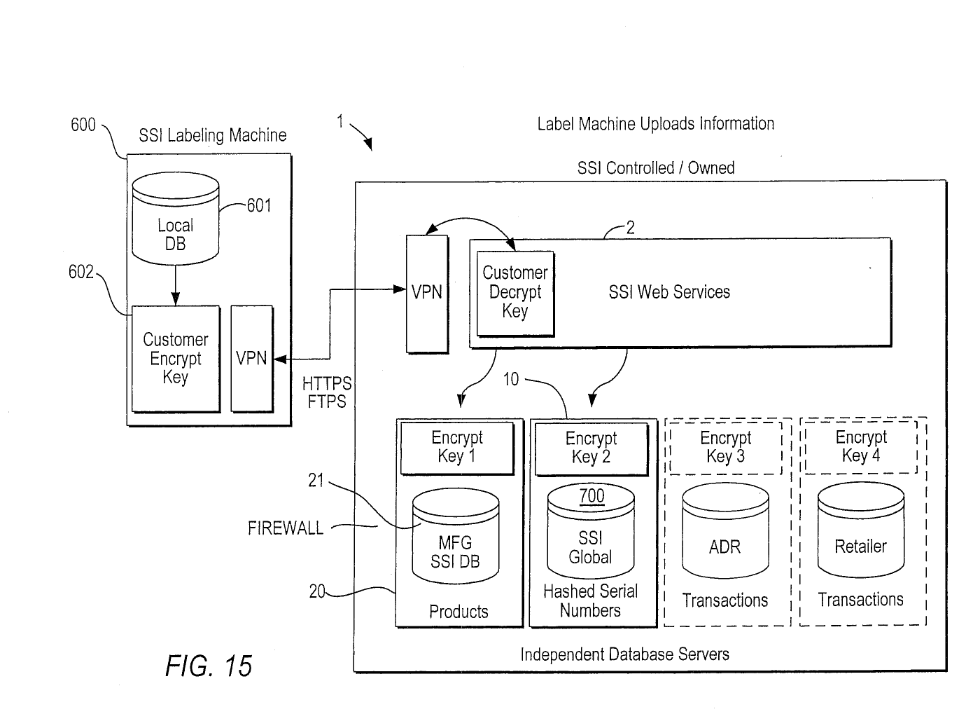

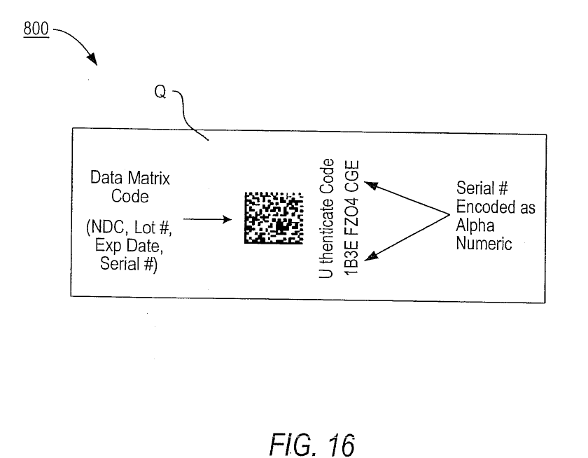

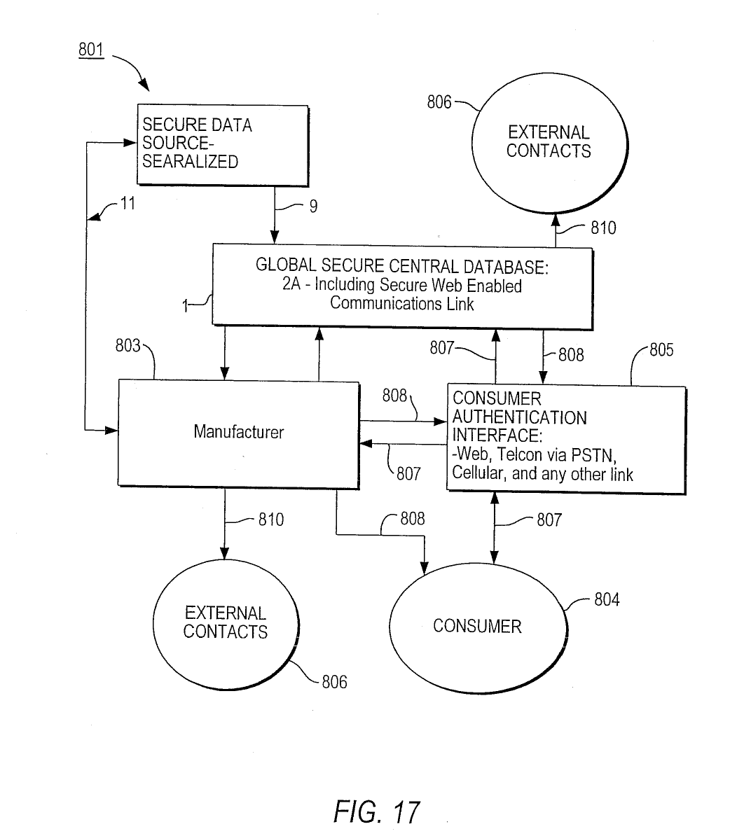

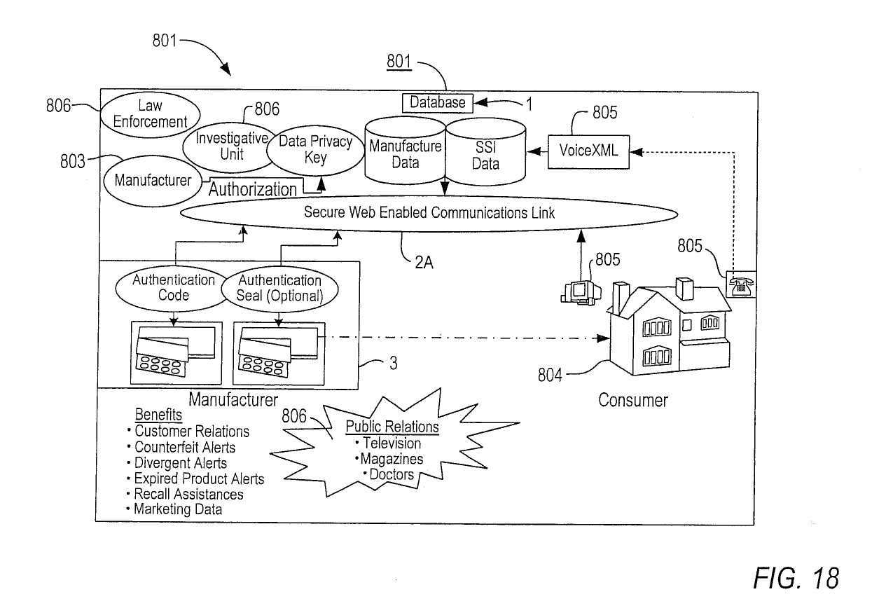

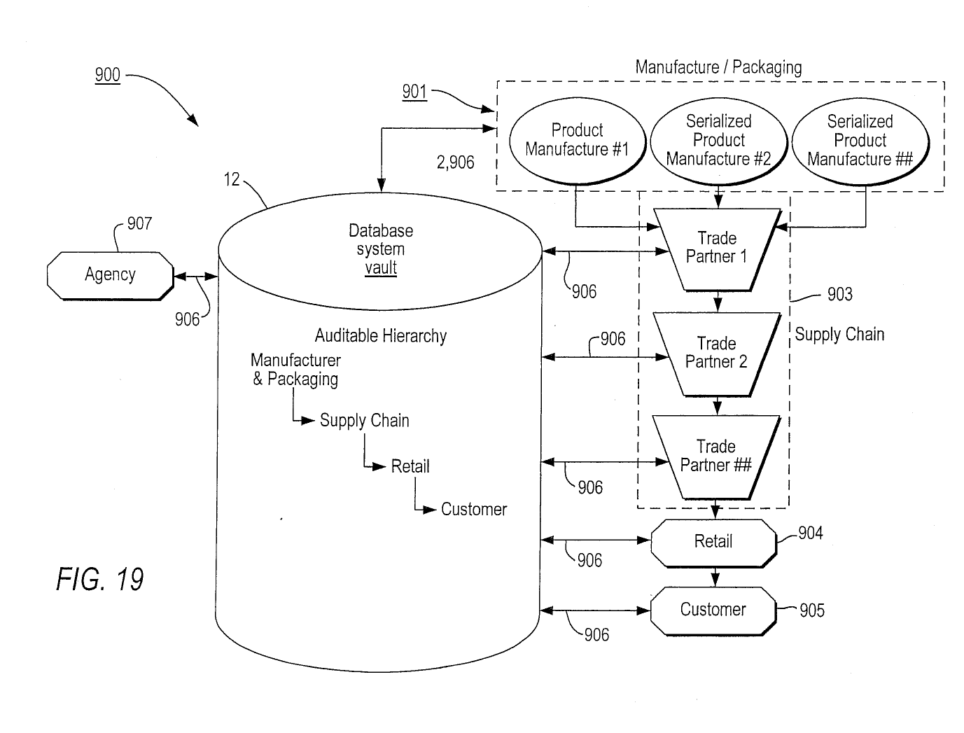

FIG. 1 is a schematic data exchange system enabling secure access across a secure authentication system according to one embodiment of the present invention.

FIG. 2 is a schematic secure data delivery system accord to one embodiment of the present invention.

FIG. 3 is a schematic depiction of a secure validation access according to one embodiment of the present invention.

FIG. 4 is a schematic of a variety of encryption and decryption transfers involving multiple access portals.

FIG. 5 is a schematic representation of a manufacturer specified recall noting the transfer of a manufacturer specific encryption key.

FIG. 6 is a schematic representation of the managing host (here shown as SSI) decrypting the manufacturer's encryption key and locates affected serialized numbers.

FIG. 7 is a schematic representation wherein the managing host accesses all recall affected products throughout the system.

FIG. 8 is a schematic representation where the managing host delivers encrypted reports to selected and authorized parties (here a retailer).

FIG. 9 is a schematic representation during a counterfeit detection scenario wherein a point of sale (POS) system submits a scan and the system detects a counterfeit.

FIG. 10 is a schematic representation of the response by managing host to notify the point of sale (POS) of the counterfeit scan.

FIG. 11 is a schematic representation of the generation of an encrypted counterfeit report to a retailer with precise location and product information but not secure manufacturer information.

FIG. 12 is a schematic representation of an encrypted counterfeit report to a manufacturer with product identification only relevant to that manufacturer but not confidential retailer information.

FIG. 13 is a schematic representation of the transfer of an encrypted counterfeit report to a state agency (here the FDA).

FIG. 14 is a schematic representation of an integration between a secure labeling system at a contractor's labeling site and authentication of that labeling machine with an integration via a secure transfer to a managing host location so as to authenticate the labeling system (machine or system) prior to, during, or at the end of a labeling or scanning run or at another selected time.

FIG. 15 is a schematic representation of an upload of secure labeling machine serialized data following a labeling system operation to develop serialized and secure data. This cycle may be conducted many times throughout a labeling system operation, during post operation review, or at another selected time.

FIG. 16 is an example of a unique product identifying code positioned via a contracted labeling device on a product package.

FIG. 17 is a schematic flow chart of one aspect of the present invention.

FIG. 18 is a more detailed schematic flow chart of one aspect further developed from FIG. 17 as a post-point of sale information or communications system.

FIG. 19 is a representational chart of an overall system structure between the multiple parties interacting with the present proposed system.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified fowl and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar tennis with their inflectional morphemes do not necessarily denote direct and immediate connections, but also include connections through mediate elements or devices.

Referring now to FIG. 1 a secure system 1 capable of global management of data and secure systems with physically separate data and with integrated master data includes a representative managing communication module 2, such as a web-based exchange server allowing flat file delivery or more complex data delivery and multiple-node transfer as will be discussed. In practice a plurality of such communication modules may be employed in a linked or independent manner without departing from the scope or spirit of the present invention.

Provided within secure global system 1 are a plurality of independent data base systems for storing, authenticating, and tracking/tracing a change of custody of an individualized serialized item stored in a linked hashed code, as will be discussed. As used herein the phrase serialized item or serialization is to be broadly interpreted to indicate the ability to define a unique designation for a particular item; package (for example a pharmaceutical package), a container, a delivery system (for example a multi-package or a single syringe or caplet), a part (for example an aircraft part), or other unit of trade which it will be desirable to identify throughout a manufacturing supply chain, a global delivery chain, or at a customer end point. As will be appreciated, having studied the present disclosure, this system allows any type of product to be identified and securely managed.

In the current non-limiting schematic representation, a managing global (identified as “SSI-Global”) data base system 10, at least a first third-party manufacturing data base system 20, and at least a first third-party product supply-chain party (ADR) data base system noted at 30, wherein the supply chain party (ADR) is for example a trading partner or a transportation partner or party along the supply chain, retail chain, or other chain of commerce).

It will be recognized, that while the present schematics depict one or more ADR database systems 30, one or more manufacturing database systems 20, and one or more manufacturing data base systems 20, nothing herein shall so limit the shared system 1, and multiples of differing types of databases, and even different geographic locations for databases, may be employed in a secure manner without departing from the scope and spirit of the present invention.

Managing database system 10 includes a managing validation module 11, an administration login 12 for enabling managing control, and an operating managing encryption/decryption key module 13 enabling system 1 to encrypt any data within respective databases according to the managing encryption/decryption key module 13. Particular tracking information is retained within module 14 (a form of data vault) relating to, for example, manufacturer, lot, expiration date number, (or any other type of data in a non-limited list as noted in the incorporated references) and an item-unique or item-specific serial number in a hashed encodation. It shall be noted that the tracking information, and faun of the information shall be recognized as non-limiting to a particular type, listing, description or other limitation but shall be recognized as generally referring to a serialized tracking identifier. Similarly, in the present embodiment, database module 10 enables the hashing of the particular unique serial number in a non-reversible manner, allowing the hashing process to serve as an additional layer of decryption.

It shall be recognized that individual database units 10, 20, and 30 are desirably, but not mandatorially physically separated, and that no single login system has access to all data other than administrative login module 12, and that respective database units are blind to each other but for the security system discussed herein.

Manufacturer database system 20 is structured to include a particular customer (here the manufacturer) secure log in module 15 allowing customer access to the manufacture database 10 so that the customer may store additional or different information within this particular database system separate and safe from intermingling with other data. System 20 may readily identify a manufacturer's data as private data (meaning it will not be transmitted without Manufacturer permission) or available data (meaning that information such as an expiration lot, which may be transmitted down-stream along the product supply chain in a public manner (e.g., on a product box, and in reports provided to retail customers or transporters). In this way it will be recognized that data may be private data or available data, and may have differing sub-levels in-between (for example where additional of (but not all) private data are transmitted to a governmental regulatory body to meet applicable regulatory codes.

Additionally, database system 20 includes a management enabling encryption/decryption key module 16 and a respective administrative login module 17 allowing access by administrating authorities.

Specific designated manufacturing locations (for example) (noted as Mart 1, 2, 3) are designated as 18A, 18B, 18C respectively and via programming systems (here a SQL view layer) 19 into a data vault module 21 in the manufacturer's database 20 or in a separately held and designated “manufacturer's” database. Manufacturing database 20 need not be at a manufacturer's location, and may be at a secure administrative location, with a specific designation for that manufacturer's use under a management or system contract.

Similarly to manufacture (third-party) database system 20, any other third-party database system 30 includes similarly structured elements not otherwise discussed. For example, a particular pharmaceutical company may be repackaged by a supply stream re-packager, or other customer having a database 30, and may need to access secure system 1 to input package transfer information for each respective product transaction.

Referring now to FIG. 2, a secure information delivery process (of secured data is depicted from infrastructure global system 1 (shown reduced). Wherein an external customer system 100 (for example a customers or manufacturer's personally owned database) receives encrypted data 101 either via a web services module 102 or via simple file transfer 103 in an electronic medium, so that each encrypted data transfer is encrypted by the customer's designated encryption/decryption keys by global managing system 1. For example, it will be understood that global system 1 stores data in an encrypted format, encrypted according to the administrator's “global” designated encrypted keys for that customer or according to the administrator's designated encryption key, the data is decrypted by the global key, then re-encrypted by the customer's unique encryption key before storage as a flat file or transferred via the interne.

It will be recognized that following customer receipt in local system 100, the customer decrypts the data via the customer's decryption key 104 to generate customers local copy 105 for customer use.

As noted there are two PGP keys employed herein, and the customer dictates lock and unlock keys, such that they cannot readily change, but the passwords to access the same can readily change for improved convenience. The global storage system is stored in the global or customer encrypted format and never un-encrypted except by customer or the global module service. The global module system 1 employs the global key on the way out then re-encrypts the data with the customer's own key.

Referring now to FIG. 3 an alternative authentication process, system, and method is provided wherein a verification ping/authentication is provided via an external web browser system 200 providing transfer of a scanned product (pharmaceutical product for example) bar code transferred via conventional java script of PHP, etc. Upon receipt by global system 1 (which will be recognized as also described as the managing infrastructure system or a managing or controlling system), managing communication module 2 receives the same and employing global database 10, as described, and global systems encryption key accesses data vault 14, determines YES/NO (or Pass/Fail) if a secure record exists and transfers a this message securely. This is known as a simple “ping” request for authentication.

Simultaneously, global system updates global data base 10 in a fully encrypted manner noting who “pinged” requesting authentication, and records, for example; the IP/URL address employed, date, time, duration, last transfer server, etc., and updates the global DB accordingly to show the ping-event occurred.

Referring now to FIG. 4, and before entering further detailed discussions of various procedures enabled by the proposed system a series of secure data transfers are discussed within the scope of the present global system 1 when considered in view of the earlier Figures and those that follow. These procedures include upload of initial serialized data (for example from a label generating and applying machine at a manufacture applying a unique and serialized (and hashed) bar code), a web request from a customer requesting data or a file (for example a request from a manufacturer for all products manufactured and shipped during a defined period), and a confirmation/verification request as discussed in reference to FIG. 3.

In procedure 1 (Upload), a manufacturing label machine generates and initially encrypts label data (individual or multiple) using a customer/manufacture key at step A. The encrypted data is then transmitted either via the web/HTTPS or via a flat file on a flash drive for example, to the global system or management system or managing infrastructure system at step B. Upon receiving the encrypted data fire wall F offers a secure gateway for all transfers and data. At a further step C, the global management system (here shown as SSI without limitation) decrypts the customer-encrypted data according the earlier provided decryption customer key at step C. Thereafter, the global management system re-encrypts the data according to the global management systems internal key designated for that particular customer in a step D, and transfers all or portions of the now re-encrypted data to one or more secure databases (shown here as a generic DB). It is important to note that each individual customer data base is encrypted via a global system encryption key that is unique to each customer, thereby preventing unintended data intermingling or mis-transfer providing a highly secure system with an auditable trail.

In an alternative procedure 2 (Web Request) or 3 (File Request) may result in a request for a responsive transfer of an encrypted file via the web step E or via a physical transfer or FTPS transfer in a step G. In each case, global system receives the request and accesses a specific database DB for the customer and decrypts the data according to the global system internal key for that specific customer in a step H and then re-encrypts the data according to the specific customer key in a step I prior to transmission through the firewall F. Following encryption step I, the global system transfers the same through firewall F along steps E or G to the customer. At the customer, in a step K, the customer decrypts the data according to the customer key. As a result, all transfers are encrypted specifically to a customer/requestor prior to exiting the secure database, and no data is stored in a designated database according to a customer's/requestors encryption—only according to the management encryption specific to that customer/requestor.

In yet a further alternative procedure 4 (Ping/Authentication Request) similar to FIG. 3, wherein a specific simple Pass/Fail Go/No type request is made incorporating the transfer of a specific bar code encodation (via any form of readable matter) in an unencrypted manner in a step L. This data is transmitted via a step M to the global system and the global system in a step N accesses the global database via secure global login to confirm the existence of the hashed serial number and transmits a simple acknowledgment to the requestor.

Referring now to FIGS. 5-8 a recall scenario is discussed according to one embodiment of the present system.

Referring now specifically to FIG. 5, a manufacturer delivers an electronic encrypted recall document identifying specific serialized lot information. The recall document or request is encrypted according to the manufacturers encryption/decryption key and is received via flow 200 into global secure system 201, where the recall document data is decrypted according to the manufacturer's key. Referring now to FIG. 6 specifically, the decrypted document is then encrypted according to the global system encryption key (either globally or according to a specific encryption key for the specific customer) here shown at step 202 and access is provided to the global individual database to correctly locate hashed serial number entries within the requested lot or product range. Here global system 201 considers the results of the decrypted document and locates all affected numbers in the global database.

Referring now to FIG. 7, with the awareness within global managing communication module 2 of the affected numbers, global management system 201 locates all affected products anywhere throughout the supply chain databases, here shown as retailer transactions database 220 or product transfer database 221 (for example a trans-shipper). Note, databases 220, 221, and even the individual manufacture database are merely designated databases within larger global system 201 and are not limiting to the present example.

Referring now to FIG. 8, upon global system 201 having located all affected products anywhere throughout the individual database systems this data is decrypted from the management encryption and formed into a report and encrypted reports (encrypted according to the recipient customers known individual encryption key) are transferred to specific third party customers here retailer 240, where customer/retailer 240 decrypts the received report employing their own decryption key of their own for review. The retailer 240 does not have the manufacturer's encryption key and so could not recognize any aspect of the original manufacturer's recall notice or any report transmitted to the manufacturer. As a result, the transmission from the manufacturer to the retailer exists only through the managing structure and neither can see the private data of the other. Of course, the data originator (here the manufacturer) may designate their data recorded in the management construction as being private data, available data (for release) or at different levels of release-permission (for example more may be released to a government regulation body).

It shall be understood, that while the present description employs common acronyms for Internet transfer and database management operations, such as HTTPS (hyper text transmission protocol), FTPS (File Transfer Protocol), or VPN (virtual private network), nothing herein shall limit this applications to those specific systems, methods, or modes of operation as they are merely explanatory in nature as long as the stated operation is accomplished.

It shall also be recognized that global system 201 (and optionally and separately each database) managed within a greater management infrastructure is continually enshrouded in at least one initial firewall systems and that each designated database internal thereto has additional respective firewall systems. It will also be recognized that the use of the VPN system allows a third level of encryption for the transfer itself. The hashing can be according to any hashing algorithm but it cannot be un-hashed once the process has occurred. The hashed result can be decrypted and re-encrypted multiple times.

Referring now to FIGS. 9 through 13, a counterfeit detection is enabled by the proposed system 1 as discussed herein. In FIG. 9, a point of sale system (POS) system 300 includes a point of sale data base 301 and an associated scanning or encodation entry stem and the transmission of the same via a virtual private network. For example, at a retailer (e.g., CVS Pharmacy) a pharmacological product having an individual serialized code is scanned, images, or read (for example an RFID signal is read or a bar code is scanned, etc.) This information is transmitted via the world wide web to the secure global system land initially into global managing communication module 2 where the code is originally transmitted to global database 10, encrypted into a hashed encodation of a serial number via encrypt key 400, and a comparison is run with all earlier recorded authorized hashed serial numbers from product suppliers and manufacturers.

In FIG. 10, the comparison with authorized authentic hashed serial numbers reveals a counterfeit scan (or a non-approved scan) and such a signal or record of non-authentication is transmitted from global database 10 to global managing communication module 2 back to point of sale system 300 via the VPN. In a next step (FIG. 11) where the point of sale system in a retailer 330 receives an encrypted counterfeit report with point of sale system location and other information (product identification, time, date, purchaser or clerk information etc.) The report transmitted from global system 1 is encrypted prior to sending into a designated retailer encryption to preserve security and does not include any manufacturer designated private data. As an option, the counterfeit P.O.S. report transmitted to retailer 330 may not be encrypted, and may be transmitted via any conventional communication pathway in a secure or non-secure methodology without departing from the scope and spirit of the present invention.

Referring now to FIG. 12, following transmission of an encrypted counterfeit report to manufacture 500 preferrably includes only product identification (lot, serial number, mfg date, expiration date etc.,) and does not include any retailer or POS contracting party private data. While the present scenario envisions that only an encrypted counterfeit report is transmitted to manufacture 500 with product identification employing secure encryption to the manufacturer's database, it is additionally envisioned that global system 1 may be additionally enabled to transmit encrypted reports of the counterfeit scan to any one of a group of previously designated parties (to multiple manufacturers, to cross-licensed manufacturers, watch-dog agencies, etc.), including manufacturing managing offices, a manufacturer's internal transfer agents, designated distribution center etc., according to a specific programming. In one or more of these transfers differing encryptions specific or customized to the report receiver may be employed using like keys, and the report may be tailored or restricted to the specific report recipient, type of report (meaning the information will differ depending upon the report).

In FIG. 13 an encrypted counterfeit report (which may include party private data or portions of the same, or party available data, as can be designated by the party providing the data) is transmitted to a third party state agency 550 for safety, here the federal Food and Drug Administration (FDA), although global system 1 may be configured to transmit additional encrypted counterfeit reports to other state agencies for example a specific state agency for consumer protection etc. Thus, while the image is simplified, it is recognized that the present invention envisions a broader concept wherein a designated recipient 550 may receive a customized counterfeit report 551 (encrypted or not encrypted with an agency key) according a system specified encryption key specific to the recipient as designated by the managing infrastructure system 1.

Referring now to FIGS. 14 and 15 a manufacturing labeling process is depicted where a manufacturer labeling machine 600 or one of the labeling machines 600 leased or rented etc. from global system 1 under a party-party contract is authenticating a connection with global system 1 at a desired time period. Machine 600 is actually a serialized labeling system including a local database 601, and a customer or unique contracting party encryption key 602 specific to the machine owner (manufacturer) and potentially unique to the machine itself.

Customer encrypted key 602 is additionally specific to the particular labeling machine 600, where a manufacture may operate with more than one machine. Consequently, each (of potentially many) labeling machine systems 600 employs an authentication process with global system 1 via global managing communication module 2.

Based upon an initial authentication process a particular machine transmits customer encrypted key data to global communication module 2 where it is decrypted employing a customer decryption key within global system 1, and following authentication, a transfer of data, particularly hashed serial numbers for each label but not limited thereto, is initiated and converted to via global encryption key 2 specific to global secure database 10, to a location within a secure global database 10's data vault 700 that is particular and unique to the contracting party. As a consequence, following an initial authentication labeling machine 600 uploads data and selected data elements, particularly hashed serial numbers, lot, expiration date, and manufacturer information is transmitted to global database 10 (hashing may occur after transfer but prior to entry to the database).

Additionally, a global system encryption key 2 unique to the particular manufacture is employed to differently encode the uploaded data to the manufacturer's separate database 20 and into the manufacturer's data vault 21 within that database as transferred out of global system 10.

In this way, each customer/manufacture database (of any kind including the secure global database 10, is encrypted via an encryption key unique to each designated database and controlled by the global system, no external third party encryption key is employed to encrypt data within the customer's designated database.

As a consequence of the authentication and uploading process depicted within FIGS. 14, 15, and elsewhere within the present disclosure, the present global system enables an improved security, a streamlined data flow, and a ready expandability for additional databases/customers/manufacturers by simply additionally identifying unique encryption keys, and database structures for each respective player.

As an additional consequence, one of skill in the art will readily appreciate that at least one of the proposed benefits of the present invention is readily achieved.

As an additional benefit, the serial numbers for each respective item are hashed (a one-way encryption), making serial numbers themselves completely unrecoverable, even to the global manager system. The only location of an actual serial number would be on the actual serialized item itself. Yet, the proposed global infrastructure system 1 can still authenticate by hashing a queried serial number and submitting the hashed serial number to the global system in a comparison to the doubly-secure database of hashed serial numbers.

Additional benefits allow software and encryption keys, owned solely by the global system, to operate the only way to reconstruct a complete data set for a serialized item. Only the proposed global system can reassemble the complete puzzle across the entire supply chain from manufacturer and labeling machine to end purchaser.

One of ready skill in the art will appreciate that the proposed global system, and division between secure third-party databases constructed of independent database servers housing data, which by itself, has no value in authentication or tacking serialized items (because each database is a separate machine blind to the others, requiring the global system to recombine the individual data stream).

As noted above, the present application incorporates fully by reference a number of earlier disclosures as assitive, but non-required and non-limiting materials to further enliven the present materials.

Similarly, while the present disclosure is broadly constructed to receive and enable transfer of any known or to-be-developed serialized identifier in a secure manner without limitation, the incorporated references provide multiple alternative examples of such serialized identifiers and related systems. Similarly, while the present global system may readily receive encrypted serialized data from any of a variety of sources using the provided structures, the incorporated references provide reference examples where such encrypted data may be transferred to-and-from (i) chain members, (ii) retailers, (iii) supply chain members, (iv) individual consumers, (v) product manufacturers, and (vi) from other sources including the noted global management system without limitation upon the scope of the present invention. As an example, a serialized data matrix encrypted code may be transferred from a variety of sources while similarly a serialized (meaning unit specific) RFID signal may be similarly encrypted, transferred, verified, etc. and otherwise operate within the scope of the present invention. Consequently, the present disclosure is not limited to a particular form of electronic serialized code system.

As will also be recognized herein, the discussed data system employing a data vault concept additionally enables a business model allowing charging of third parties and customers based upon various factors, such as disk storage space, indexing services, data base utilization, report generation, maintenance and backup or restore services to protect the database within the controlled global firewall. As a consequence, the present discloser envisions multiple methods of operating a business enabled according to the above discussed apparatus, systems, and methods.

As used herein, the concept of a Data Vault shall be recognized generally as a uniquely linked set of tables or fields managed and split in a supporting and functional manner. As used herein a data vault design shall be recognized as being flexible, scalable, consistent and adaptable to the needs of the particular enterprise as discussed herein. Broadly, a data vault is a form of data model that is architected (created) specifically to meet the needs of customers or system managers involved with data warehouses. The proposed data vault herein is designed to meet the needs of the system and shall not be confused with a simple data mart. As discussed the proposed system employs a data vault operating with correct hardware and database engine support it.

The proposed data vault shall be recognized as foundationally strong and relying generally on adapted mathematical principles that support a customized data model or schema that supports the functions discussed herein, including many linkages and standard table structures. The differences lie in relationship representations, field structuring and granular time-based data storage.

Referring now to FIGS. 16, 17, and 18 an example of the proposed infrastructure management system is proposed with specificity to a post-point of sale occurrence.

FIG. 16 is an example of a unique product identifying code label 800 positioned via a contracted labeling device on a product package where a particular data matrix code is applied (which contains an NDC, Lot number, Expiration Date, and a Designated Serial Number unique to that label) at position Q. Also noted is the designated serial number in an alpha numeric code. All of this associated information is stored in the specific manufacturer database and is used to correctly identify the individual product package, as well as provide additional information about the product, such as dosage, strength etc. in this example—information transmitted by the manufacturer via the above noted system. As will be noted, for security purposes, the individual serial numbers, which are unique identifiers to the label/product, are hashed for storage as noted above creating a one-way encryption technique so that only a comparison of hashed numbers can be conducted.

As noted in FIGS. 17 and 18, a post point of sale anti-counterfeiting system 801 includes minimal elements to function but allows, via an adaptive structure to incorporate many modifications and alternative communication pathways. It will be additionally noted that the “POS” system noted in FIGS. 9-12, and 13 depicts the process for delivering the return Pass/Fail notification and distributing other related reports resulting from a post point of sale inquiry.

Returning to FIGS. 16-18, prior to a product being purchased at a point of sale, a global secure central database system 1, similar to that noted in FIGS. 1-15 is provided with access via the web 2A to a secure database infrastructure storing unit specific, codes received from manufacturing source 803 via a secure data link 11 during an initial manufacture or labeling and passed along secure link 9 to database structure 1. This will be recognized as an exemplary view of the global system noted previously.

It will be recognized that within secure central database system 1 a secure web enabled communications link 2A or other communication system enables multiple secure authentication based communications. Similarly, secure database 2A may incorporate specific secure sub-databases for manufacturing data and other data types as were noted above. Because the present feature is focused on post-point of sale, the originating process of the data (noted in detail earlier) is eliminated.

Upon purchasing an identified product a consumer 804 may access a consumer authentication interface 805 via an information pathway 807 allowing consumer 804 to access a secure interface for inputting consumer information, product, information, and other information as manufacturer 803 or secure central database 2A may require. It will be recognized as within the scope of the present disclosure that consumer authentication interface 805 may related directly to manufacturer 803 or database 2A or both directly on how secure system 801 is arranged without departing from the spirit and scope of the present invention. For example, consumer authentication interface may be the web, a call in phone center under contract to one of the parties, or a direct phone link to the manufacturer.

Following such consumer input, the information is transmitted via one or more pathways 807 and a suitable authentication notification is returned via pathways 808 following an access of central database 2A (either directly by the database or via a secondary request by manufacturer 803 in the pathways shown).

Following such a determination of authentication, either or both of manufacturer 803 or central database 2A may contact one or more external contacts 806 via pathways 810 to carry out additional actions. External contacts 806 may include law enforcement, investigation units, retailers, public relation firms, and others to conduct additional steps secondary to the authentication process.

One of ready skill in the art will appreciate that the proposed global system may be readily modified without departing from the scope and spirit of the present invention.

Similarly, while the present disclosure is broadly constructed to receive and enable transfer of authentication based on any known or to-be-developed serialized identifier in a secure manner without limitation, the incorporated references provide multiple alternative examples of such serialized identifiers and related systems. Similarly, while the present post point of sale anti-counterfeiting system may readily receive encrypted serialized data from any of a variety of sources using the provided structures, the incorporated references provide reference examples where such encrypted data may be transferred to-and-from (i) chain members, (ii) retailers, (iii) supply chain members, (iv) individual consumers, (v) product manufacturers, and (vi) from other sources including the noted global management system without limitation upon the scope of the present invention. As an example, a serialized data matrix encrypted code may be transferred from a variety of sources while similarly a serialized (meaning unit specific) RFID signal may be similarly encrypted, transferred, verified, etc. and otherwise operate within the scope of the present invention. Consequently, the present disclosure is not limited to a particular form of electronic serialized code system.

While the present discussion has been focused principally on an exemplary use for pharmaceutical products and related markets and systems, nothing herein shall be so limited. Those of skill in the art will readily recognize that the present discussion may be applied to other industries without departing from the spirit and scope of the concepts herein. Those other industries include, but are not limited to the automotive, aviation, intermodal transportation, and homeland security industries.

The above features are similarly represented in FIG. 18 in a more pictographic form without departing from the scope and spirit of the present disclosure.

In an exemplary discussion involving a pharmaceutical manufacturer's packaging line, module prints a unique, encrypted, serialized alphanumeric code together (“UESAC”) with a composite barcode. The UESAC contains the encrypted information of standard linear barcode, including the lot, expiration date, and NDC numbers. The composite barcode contains substantially more information, but for the present purpose the code linked to the proposed database system allows expansion of the system to a complete e-pedigree using the proposed system noted herein. As a business process, through advertising that is part of the normal advertising campaign for the selected drug, the pharmaceutical company will make the consumer aware of the simple steps necessary to verify the authenticity of the drug they have purchased regardless of the source.

As exemplary steps, via the communication links in interface 805, the consumer will enter at the encrypted UESAC, a method of identifying himself, and purchase location (geographic information) information onto the special, private labeled website or through a touch tone phone. At that point the product will be authenticated back to the consumer and at the discretion of the pharmaceutical company or other contracting party member (for example a pharmaceutical re-packager or government agency), the consumer will be able to print out a record of authenticity or similarly, if done through a phone link, that record of authenticity can be mailed to the consumer.

At the same time the drug company or party contracting member is receiving specific information on lot numbers correlated with geographic location of individual packages being sold, making the database of tracking down counterfeits and illegally diverted drugs more robust. Once the specific serial number is checked off in the secure and as having exited the supply chain the database any subsequent input of the same number such as from a counterfeit carton, would immediately be identified as being fake. Irrespective of where the individual drug package travels, the customer can verify its authenticity at or beyond the point of purchase.

Beneficial results are suggested for this proposed adaptation of the larger infrastructure management system, including: (a) Public Relations improvement; (b) Counterfeit Alerts; (c) Expired Product Alerts, (d) Divergence Alerts (for mis-delivered products); (e) Recall Alerts, and (f) Marketing Data (which has value to marketing users and to users throughout the supply chain.

Finally, now referring now to FIG. 19, a summary representation of communication pathways supported by the present application is noted. As noted an overall infrastructure management system 900 for a serialized product distribution process and data collection system can be depicted as various communication pathways or contractual relationships where agreements for data transfer and interaction are established.

These parties include initial data generating parties 901 represented as one or more product manufacturers with a desire to track an individualized product and provide a data transfer to global system 1 via a pathway 2. A series of supply chain trading partners boxed at 903 are each parties contracting with global system 1 and receiving or desiring to track an individualized item along the supply chain. Similarly, retail parties 904, agencies 907, and ultimate consumer parties 905 each interact along contractual relationships featured by lines 906. These contractual relationships can be as narrow as consumer 905 desiring an authentication receipt and giving data in exchange, or as broad as transfers of reports to agency parties 907. As a consequence, the proposed database, infrastructure, and supporting contractual relationships and features connecting each of the parties provides an extensive auditable hierarchy and data infrastructure that is of benefit to each of the parties.

A number of acronyms are employed for convenience in the discussion above and below, and are broadly recognized by those of skill in the art. A number of acronyms are noted below as used in the text. As used herein PHP or a PHP Hypertext Preprocessor is a programming language that allows web developers to create dynamic content that interacts with databases. DBMS is a database management system. The phrase ‘schema’ or ‘schema object’ will not be limited but will be broadly interpreted and employed to describe data in one or more databases. A VLDB is a very large database as recognized as a term of art in the database management fields and MPP is an acronym representing massive parallel processing or porting depending upon context. HTTPS represents a hypertext transfer protocol for programming and transfer while SFTP is a simple (or secure) file transfer protocol. Broadly speaking a VPN is a network that uses a public telecommunication infrastructure (e.g., the web) and ensures privacy through security procedures and tunneling protocols. As a result, VPN is a form of communication over networks that are public in ownership, but emulate a private network in teems of security. Finally, the acronym “SSI” as used herein refers to the managing infrastructure entity (for example the Applicant Secure Symbology, Inc.), but the use of the phrase shall not be so limited to the entity but shall apply to a managing entity.

While the present discussion has been focused principally on an exemplary use for pharmaceutical products and related markets and systems, nothing herein shall be so limited. Those of skill in the art will readily recognize that the present discussion may be applied to other industries without departing from the spirit and scope of the concepts herein. Those other industries include, but are not limited to the automotive, aviation, intermodal transportation, and homeland security industries.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A secure data exchange and access system, comprising:
a managing data module including a managing data communication module and a plurality of independent third-party database systems corresponding to respective designated third-parties external to said managing data module, and at least one managing global database system;
said managing data module within a managing firewall system and said managing data communication module including means for controlling said managing firewall system and for enabling an encrypted access to respective said third-party and said managing global database systems;
said managing data module including a plurality of encrypted data relating to unique hashed serial numbers stored in said managing global database system;
said managing data communication module including means for enabling both encryption/decryption keys for each respective third-party database system and means for enabling a global database system encryption/decryption key;
said managing data communication module including means for receiving encrypted data from at least one of said respective third-parties encrypted according to said encryption key designated for said respective third-party;
means for decrypting said encrypted third-party data employing said third-party decryption key;
means for re-encrypting said now decrypted third-party data according to said encryption key for said global database system; and
means for storing said now re-encrypted data and for designating said re-encrypted data in at least one data base as sourced from said third-party.

2. A secure data exchange and access system, according to claim 1, wherein:
said managing data communication module, further comprises:
means for transferring said now encrypted data from said at least one database to said designated third party;
said means for transferring including means for decrypting said encrypted data according to said global database system encryption/decryption keys and for re-encrypting said decrypted data according an encrypting key for said respective designated third-party; and
means for transmitting said third-party encrypted data to said respective designated third-party, whereby said designated third-party is prevented from receiving said global database system encryption/decryption keys and receives only data encrypted by their own respective encryption/decryption keys.

3. A method for enabling a secure data exchange and access system for data exchanges between said system and a plurality of customers, comprising the steps of:
providing a global exchange system for interconnecting individual separately designated databases;
providing a plurality of unique internal database encryption keys operable by said global exchange system specific to each respective separately designated database;
providing a global encryption key specific to said global exchange system;
providing a plurality of designated customer encryption and decryption keys specified by respective said designated customers;
providing a secure data transmission mode for inputting customer data into respective individually designated databases, comprising the steps of:
receiving data encrypted by said designated customer encryption key
decrypting said encrypted data using said designated customer decryption key;
re-encrypting said decrypted data using said unique internal database encryption key to said respective customer designated database; and
storing said encrypted data in said secure database.

4. A secure data exchange and access system, comprising a data managing infrastructure entity having a secure data communication module with a firewall management structure for encrypting and decrypting data transmissions between a plurality of system customers according to instructions from said data managing infrastructure entity;
said system having:
a managing data vault module for storing separate customer encryption/decryption keys provided by respective customers, separate system encryption/decryption keys assigned by said system to each respective customer and unknown to said customers; and hashed value data for items having unique serial numbers provided by ones of said customers;
a plurality of independent customer-designated data vault modules linked to said data managing infrastructure entity for separately storing encrypted customer data for each said customer;
a first mode of operation in which secure data communication module receives encrypted customer data for said item including said hashed value data encrypted by at least one said customer according to said customer encryption key through said firewall management structure, accesses said managing data vault module to retrieve said separately stored customer decryption key, and decrypts said encrypted customer data; and
a second mode of operation in which said secure data communication module accesses said managing data vault module to retrieve said separately stored system encryption key assigned to said customer; re-encrypts said customer data according to said separate system customer encryption key, and stores a portion of said system encrypted customer data in respective said independent customer-designated data vault module and linked to said hashed value data stored in said managing data vault module.

5. A secure data exchange and access system, according to claim 4, said system having:
a third mode of operation in which a request for customer data is received from one of said system customers by said secure data communication module;
said data managing infrastructure entity accesses said managing data vault module and retrieves said separate system encryption/decryption key assigned by said system to said respective customer; directs said managing data vault module and said respective independent customer-designated data vault module to decrypt said requested customer data; and
a forth mode of operation in which said secure data communication module re-encrypts said requested customer data according to said customer provided encryption key and transmits said encrypted data to said one of said system customers.

6. A secure data exchange and access system, according to claim 4, said system having:
a fifth mode of validation operation in which a validation request is received from a requestor by said data managing infrastructure entity, said validation request including an unhashed unique serial number for said item;
said managing data vault module hashing said submitted serial number and comparing said hashed serial number to said hashed value data relating to said unique serial numbers initially provided by ones of said customers; and transmitting at least a valid/not-valid designation to said requestor.

7. A secure data exchange and access system, according to claim 6, wherein:
said plurality of system customers include at least ones of manufacturers, item transporters, item supply chain members, a government member, and retails for said items having unique serial numbers.

8. A secure data exchange and access system, according to claim 7, said system having:
a sixth mode of counterfeit reporting operation in which upon a determination of said not-valid designation said managing infrastructure entity designates said system encrypted customer data as linked to said not-valid designation for said item; generates a specific counterfeit report for at least one of said system customers containing data designated for said one system customer; encodes said counterfeit report with said separate customer encryption key for said system customer; and transmits the same.

9. A secure data exchange and access system, according to claim 8, wherein:
said system customer is a manufacturer; and
said specific counterfeit report for said manufacturer includes item identification data only.

10. A secure data exchange and access system, according to claim 8, wherein:
said system customer is a retailer; and
said specific counterfeit report for said retailer includes location information.

11. A secure data exchange and access system, according to claim 8, wherein:
said system customer is a government member; and
said specific counterfeit report for said government member includes item specific identification data and location data.

12. A secure data exchange and access system, according to claim 8, wherein:
said system customer is one of said item transporters and said item supply chain member; and
said specific counterfeit report for said one includes only said non-valid designation.

13. A secure data exchange and access system, according to claim 6, wherein:
said validation operation in which said validation request is received from said requestor by said data managing infrastructure entity occurs after a point of sale of said item, thereby enabling a post-point-of-sale validation determination.

14. A secure managing system for managing access to a plurality of independent database structures managed by a managing infrastructure system; said steps for managing access including:
providing a global exchange system for interconnecting individual separately designated independent database structures;
providing a plurality of unique internal database encryption keys operable by said global exchange system specific to each respective separately designated database structure;
providing a global encryption key specific to said global exchange system;
providing a plurality of designated customer encryption and decryption keys specified by respective said designated customers;
providing a secure data transmission mode for inputting customer data into respective individually designated databases, comprising the steps of:
receiving data encrypted by said designated customer encryption key
decrypting said encrypted data using said designated customer decryption key;
re-encrypting said decrypted data using said unique internal database encryption key to said respective customer designated database; and
storing said encrypted data in said secure database.

15. A system associated with a plurality of contracting parties for securing data transmissions from a plurality of data source parties and for providing secure reports to a plurality of data end user parties, comprising:
a shared infrastructure entity comprising a data managing infrastructure entity having a secure data communication module with a firewall management structure for encrypting and decrypting data transmissions between a plurality of system customers contracting with shared infrastructure entity according to features of said data managing infrastructure entity; said features including:
a managing data vault module for storing separate customer encryption/decryption keys provided by respective customers, separate system encryption/decryption keys assigned by said system to each respective customer and unknown to said customers; and hashed value data for items having unique serial numbers provided by ones of said customers;
a plurality of independent customer-designated data vault modules linked to said data managing infrastructure entity for separately storing encrypted customer data for each said customer;
a first mode of operation in which secure data communication module receives encrypted customer data for said item including said hashed value data encrypted by at least one said customer according to said customer encryption key through said firewall management structure, accesses said managing data vault module to retrieve said separately stored customer decryption key, and decrypts said encrypted customer data; and
a second mode of operation in which said secure data communication module accesses said managing data vault module to retrieve said separately stored system encryption key assigned to said customer; re-encrypts said customer data according to said separate system customer encryption key, and stores a portion of said system encrypted customer data in respective said independent customer-designated data vault module and linked to said hashed value data stored in said managing data vault module.

16. A computer readable medium carrying one or more sequences of instructions for controlling access to data in a secure data exchange and access system, wherein executions of one or more sequences of instructions by one or more processors causes one or more processors to perform the steps of:
providing access for and providing a global exchange system for interconnecting individual separately designated databases;
providing a plurality of unique internal database encryption keys operable by said global exchange system specific to each respective separately designated database;
providing a global encryption key specific to said global exchange system;
providing a plurality of designated customer encryption and decryption keys specified by respective said designated customers;
providing a secure data transmission mode for inputting customer data into respective individually designated databases, comprising the steps of:
receiving data encrypted by said designated customer encryption key
decrypting said encrypted data using said designated customer decryption key;
re-encrypting said decrypted data using said unique internal database encryption key to said respective customer designated database; and
storing said encrypted data in said secure database.

17. A post point of sale anti-counterfeiting system, comprising:
a consumer authentication interface means for enabling a consumer to access an authentication interface;
said authentication interface including means for receiving both a consumer data set and a product serialized identifier and for accessing at least one of a manufacturer authentication database and a globally secure central database;
said at least one database receiving and recording said consumer data set and said product serialized identifier;
means for determining at least one of an authentication of said product serialized identifier or a non-authentication as a counterfeit status and for transmitting the same to said consumer authentication interface for external transfer to an external consumer; and
manufacturer means for receiving said counterfeit status, said consumer data set following transmission of said counterfeit status to said consumer authentication interface, whereby said manufacturer receives immediate notice of a counterfeit status following such determination and thereby improves consumer safety and mitigates a manufacturer's liability exposure.
